(19) United States
(12) Patent Application Publication
(10) Pub. No.: US 2008/0020170 A1
(43) Pub. Date: Jan. 24, 2008

(54) Substrate possessing a transparent protective layer derived from a radiation-curable acrylate composition

(76) Inventors: Jeanne E. Haubrich, Clifton Park, NY (US); Wen P. Liao, Clifton Park, NY (US); Sona Sivakova Slocum, Malta, NY (US)

Correspondence Address: DILWORTH & BARRESE, LLP, 333 EARLE OVINGTON BLVD., SUITE 702, UNIONDALE, NY, 11553, US

(21) Appl. No.: 11/489,359

(22) Filed: Jul. 19, 2006

(51) Int. Cl. B32B 3/02; B32B 27/40; B32B 27/30

(52) U.S. Cl. 428/65.1; 428/423.1; 428/522

(57) ABSTRACT

A substate possesses a transparent protective layer derived from a radiation-curable acrylate composition which comprises:
a) at least one urethane polyacrylate possessing a number average molecular weight of at least about 400 per acrylate group and having a T_{g} of not greater than about 40° C.;
b) at least one crosslinking polyacrylate having a T_{g} of at least about 50° C.;
c) at least one hydrophobic monoacrylate; and,
d) at least one photoinitiator.

### BACKGROUND OF THE INVENTION

This invention relates to a substrate, and in particular, an optical data storage medium, possessing a transparent protective layer derived from a radiation-curable acrylate compositions.

As data storage densities are increased in optical data storage media, e.g., compact audio discs (CD), digital versatile discs (DVD) and the more recent high definition digital versatile discs (HD DVD) and Blu-ray discs (BD) (so-named for the blue-violet laser that is used to read and write to the disc), the performance requirements for the transparent, or light-transmitting, layer of the disc become increasingly stringent. Optical discs with progressively shorter reading and writing wavelengths, in particular, the aforementioned BD, have been the object of considerable developmental effort. BD is expected to replace video tape and the lower data storage density DVD within a few years. The BD format is also likely to become the optical standard for computer data storage and high-definition movies.

A typical optical disc includes a relatively thick disc-shaped thermoplastic resin substrate, a metallic reflective layer, a data layer and a transparent protective layer. In the case of BD, the protective layer can be of the single layer or double layer type, the total thickness of both types being about 100 μm.

In the two layer construction, a first 97 μm transparent layer is formed on the data layer followed by formation of a second 31 μm transparent hardcoat layer on the first transparent layer. Although the first 97 μm transparent layer does not provide abrasion resistance or scratch resistance properties, the second 3 μm transparent layer is intended to provide these needed properties.

Transitioning from the aforedescribed two layer construction to a single layer protective coating that provides abrasion resistance and scratch resistance properties would be desirable as it would significantly simplify the disc assembly procedure.

Abrasion resistance and scratch resistance can normally be achieved by forming the transparent protective layer from radiation-curable acrylate compositions which crosslink to a high degree during the curing (i.e., polymerization) process. However, most polymer-forming compositions will undergo shrinkage upon polymerization. Shrinkage of the cured protective coating induces stress between it and the substrate which in turn causes the disc to tilt. Because of the higher data densities involved and the necessary precision required of the laser light, particularly in the case of BD, an excessive degree of tilt must be avoided.

It is therefore an object of the invention to provide a substrate, e.g., an optical data storage medium radiation-curable acrylate such as CD, DVD, HD DVD and BD possessing a transparent protective layer obtained from s radiation-curable acrylate composition which undergoes minimal shrinkage during curing and remains dimensionally stable during ambient temperature fluctuations, thus avoiding excessive tilt, while exhibiting a high level of abrasion resistance and scratch resistance.

It is another object of the invention to provide an optical data storage medium possessing a transparent protective layer obtained from a radiation-curable acrylate composition which, following its curing, will provide a transparent protective coating of low modulus and, advantageously, high elasticity.

### SUMMARY OF THE INVENTION

In accordance with the foregoing and other objects of the invention, there is provided a substrate possessing a transparent protective layer derived from a radiation-curable acrylate composition which comprises:

a) at least one urethane polyacrylate possessing a number average molecular weight of at least about 400 per acrylate group;

b) at least one crosslinking polyacrylate;

c) at least one hydrophobic monofunctional acrylate; and,

d) at least one photoinitiator.

When cured, e.g., by exposure to actinic radiation such as ultraviolet (UV) light, the foregoing acrylate composition provides a coating of low modulus and high elasticity that experiences relatively little shrinkage during polymerization, undergoes expansion and contraction during daily and seasonal changes in temperature and humidity that remain within fairly tight limits and resists abrasion and scratches by hard objects such as those of metal. When pressure is applied, the coating tends to deform and when pressure is released, the coating reforms thereby avoiding a scratch.

As used herein, the term “acrylate” is inclusive of “acrylate” and “methacrylate” functionalities.

The term “polyacrylate” refers to an acrylate possessing at least two acrylate functionalities, e.g., diacrylate, triacrylate, dimethacrylate, trimethacrylate, etc.

The term “Tg” refers to the glass transition temperature of the resin derived from the acrylate(s) to which the term is applied. Thus, e.g., the description of urethane polyacrylate (a) in the aforedescribed radiation-curable acrylate composition as having a Tg of not greater than about 40° C. shall be understood to mean that the glass transition temperature of the resin derived from the polymerization of at least one urethane polyacrylate (a) is not greater than about 40° C. Similarly, the description of crosslinking polyacrylate (b) in the radiation-curable acrylate composition as having a Tg of at least about 50° C. shall be understood to mean that the glass transition temperature of the resin derived from the polymerization of at least one crosslinking polyacrylate (b) is at least about 50° C.

The term “curable” shall be understood herein to mean the full or partial curing of a composition comprising one or more curable monomers, e.g., to at least the “green” strength of the composition, the curing being achieved by any suitable means, e.g., thermal curing, curing with UV, E-beam, etc., in accordance with known and conventional procedures.

### BRIEF DESCRIPTION OF THE DRAWING

FIG. 1 is a cross sectional view of one embodiment of an optical data storage medium possessing a transparent protective coating layer formed from a radiation-curable acrylate composition in accordance with the invention.

### DETAILED DESCRIPTION OF THE INVENTION

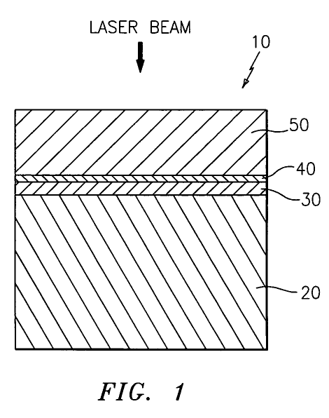

As shown in FIG. 1, optical data storage medium 10 is made up of several layers including at least one substrate layer 20, at least one data layer 30, at least one reflecting layer 40 and at least one transparent, i.e., light-transmitting, protective layer 50.

In the context of the present disclosure, a typical optical data storage medium possesses a number of polymeric components which are generally combined in superimposed horizontal layers of predetermined thicknesses whose particular values depend on the specific properties and requirements of the data storage medium. A major component of an optical data storage medium is a substrate layer (part 20 in FIG. 1). The substrate layer is typically made of a polymeric material which comprises at least one member selected from the group consisting of thermoplastic resin, thermoset resin and any combination thereof. Both addition and condensation polymers are suitable for the substrate layer.

As used herein, the term “thermoplastic polymer”, also referred to in the art as a thermoplastic resin, is defined as a material with a macromolecular structure that will repeatedly soften when heated and harden when cooled. Illustrative classes of useful thermoplastic polymers include styrene, acrylics, polyethylenes, vinyls, nylons and fluorocarbons.

As used herein, the term “thermoset polymer”, also referred to in the art as a thermoset resin, is defined as a material which solidifies when first heated under pressure and which cannot be remelted or remolded without destroying its original characteristics. Illustrative classes of useful thermoset polymers include epoxides, melamines, phenolics and ureas.

Examples of useful thermoplastic polymers include olefin-derived polymers (e.g., polyethylene, polypropylene, and their copolymers), polymethylpentane; diene-derived polymers (e.g., polybutadiene, polyisoprene, and their copolymers), polymers of unsaturated carboxylic acids and their functional derivatives (e.g., acrylic polymers such as poly(alkyl acrylates), poly(alkyl methacrylates), polyacrylamides, polyacrylonitrile and polyacrylic acid), alkenylaromatic polymers (e.g., polystyrene, poly-alpha-methylstyrene, polyvinyltoluene, and rubber-modified polystyrenes), polyamides (e.g., nylon-6, nylon-6,6, nylon-1,1, and nylon-1,2), polyesters; polyketones; polycarbonates; polyester carbonates; polyethers such as aromatic polyethers, polyarylene ethers, polyethersulfones, polyetherketones, polyetheretherketones, polyetherimides; polyarylene sulfides, polysulfones, polysulfidesulfones; and liquid crystalline polymers. In one embodiment, the substrate layer comprises a thermoplastic polyester. Suitable examples of thermoplastic polyesters include, but are not limited to, poly (ethylene terephthalate), poly(1,4-butylene terephthalate), poly(1,3-propylene terephthalate), poly(cyclohexanedimethanol terephthalate), poly(cyclohexanedimethanol-co-ethylene terephthalate), poly(ethylene naphthalate), poly(butylene naphthalate), and polyarylates. For example, the substrate layer can comprise a polyester, a polycarbonate, a polystyrene, a polymethylmethacrylate, a polyketone, a polyamide, an aromatic polyether, a polyether-sulfone, a polyether-imide, a polyether ketone, a polyphenylene ether, a polyphenylene sulfide, and any combinations thereof.

In another embodiment, the substrate layer comprises a thermoplastic elastomeric polyester (TPE). As defined herein, a thermoplastic elastomer is a material that can be processed as a thermoplastic material but which also possesses some of the properties of a conventional thermoset resin. Suitable examples of thermoplastic elastomeric polyesters include polyetheresters, poly(alkylene terephthalate), poly(ethylene terephthalate), poly (butylene terephthalate), polyetheresters containing soft-block segments of poly (alkylene oxide) particularly segments of poly(ethylene oxide) and poly(butylene oxide), polyesteramides such as those synthesized by the condensation of an aromatic diisocyanate with dicarboxylic acids and any polyester with a carboxylic acid terminal group.

Optionally, the substrate layer can include at least one dielectric layer, at least one insulating layer or any combination thereof. The dielectric layer(s), which are often employed as heat controllers, typically have a thickness between about 200 Å and about 1,000 Å. Suitable dielectric layers include a nitride layer (e.g., silicone nitride, aluminum nitride), an oxide layer (e.g. aluminum oxide), a carbide layer (e.g., silicon carbide) and any combinations comprising at least one of the foregoing and any compatible material that is not reactive with the surrounding layers.

A typical optical disc includes at least one data layer (part 30 in FIG. 1). The data layer can be made of any material that is capable of storing optically retrievable data such as an optical layer or a magneto-optic layer. The thickness of a typical data layer can be up to about 600 Å. In one embodiment, the thickness of the data layer is up to about 300 Å. The information which is to be stored on the data storage medium can be imprinted directly onto the surface of the data layer or stored in a medium which has been deposited onto the surface of the substrate layer. Suitable data storage layers are typically composed of at least one material selected from the group consisting of oxides (e.g., silicone oxide), rare earth element-transition metal alloys, nickel, cobalt, chromium, tantalum, platinum, terbium, gadolinium, iron, boron, organic dyes (e.g., cyanine or phthalocyanine type dyes), inorganic phase change compounds (e.g., TeSeSn or InAgSb) and any alloys or combinations comprising at least one of the foregoing.

The reflective metal layer(s) (part 40 in FIG. 1) should be of a thickness that is sufficient to reflect an amount of energy sufficient to enable data retrieval. Typically, a reflective layer has a thickness up to about 700 Å. In one embodiment, the thickness of the reflective layer is between about 300 Å and about 600 Å. Suitable reflective layers include aluminum, silver, gold, titanium and alloys and mixtures comprising at least one of the foregoing.

The transparent protective layer (part 50 in FIG. 1) is obtained by the radiation curing of a radiation-curable acrylate composition in accordance with the invention. The radiation-curable acrylate composition comprises:

a) at least one urethane polyacrylate possessing a number average molecular weight of at least about 400 per acrylate group and having a Tg of not greater than about 40° C.;

b) at least one crosslinking polyacrylate having a Tg of at least about 50° C.;

c) at least one hydrophobic monoacrylate; and,

d) at least one phohoinitiator.

When, following curing of the radiation-curable acrylate composition herein, urethane polyacrylate (a) become chemically integrated with the other acrylate monomers in the structure of the resulting resin, it contributes several properties thereto which are particularly desirable for its use as the protective coating of an optical data storage medium. Among these properties are good abrasion resistance and scratch resistance, reduced shrinkage and enhanced flexibility.

Urethane polyacrylate (a) is advantageously a diacrylate or triacrylate possessing a number average molecular weight in one embodiment of at least about 600 per acrylate group, in another embodiment of at least about 800 per acrylate group and still in another embodiment, a Tg of not greater than about 30° C. These and other useful urethane polyacrylates are known and in general are obtained by reaction of an isocyanate-terminated polyurethane (itself obtained from the reaction of a polyol such as a polyether polyol or a polyester polyol with a slight molar excess of organic polyisocyanate) with a hydroxyl-terminated acrylate such as hydroxyethyl acrylate, hydroxyethyl methacrylate, and the like. Assuming an equimolar reaction of isocyanate-terminated polyurethane and hydroxyl-terminated acrylate, the average number of acrylate groups in the urethane polyacrylate will correspond to the average number of isocyanate groups in the isocyanate-terminated polyurethane.

Particularly suitable for use herein are the aliphatic polyester-based urethane diacrylates and triacrylates, a number as which are commercially available from such companies as Rahn US Corp., Sartomer Company, Inc., Cytec Industries, Inc. and Bomar Specialties Co. among others. Also useful are urethane polyacrylates which have been diluted with low viscosity acrylates to reduce their viscosities such as Ebecryl 230 (aliphatic urethane diacrylate having a viscosity of about 40,000 cps), Ebecryl 244 (aliphatic urethane diacrylate diluted with 10 weight percent 1,6-hexanediol diacrylate), Ebecryl 284 (aliphatic urethane diacrylate diluted with 10 weight percent 1,6-hexanediol diacrylate), all available from UCB Chemicals, CN-963A80 (aliphatic urethane diacrylate blended with 20 weight percent tripropylene glycol diacrylate), CN-966A80 (aliphatic urethane diacrylate blended with 20 weight percent tripropylene glycol diacrylate), CN-982A75 (aliphatic urethane diacrylate blended with 25 weight percent tripropylene glycol diacrylate) and CN-983 (aliphatic urethane diacrylate), all available from Sartomer Corp.

In general, the amount of urethane acrylate (a) in the radiation-curable acrylate composition will be sufficient to impart the desirable properties to the cured resin that are mentioned above, in particular, good abrasion resistance and scratch resistance, reduced shrinkage and enhanced flexibility.

Crosslinking polyacrylate (b) imparts or contributes to several useful properties of the cured resin including reduced tack, increased glass transition temperature (Tg) and decreased gas, in particular, water vapor, permeability. One class of crosslinking polyacrylate (b) that has been found to provide particularly good results are the alkoxylated phenolic diacrylates, in one embodiment, those possessing an average molecular weight of less than about 400 per acrylate group, in another embodiment, less than 350 per acrylate group, and still in another embodiment, a Tg of at least about 60° C. Specific diacrylates of this type include ethoxylated (1) bisphenol A diacrylate, ethoxylated (1) bisphenol A dimethacrylate, ethoxylated (2) bisphenol A diacrylate, ethoxylated (2) bisphenol A dimethacrylate, ethoxylated (3) bisphenol A diacrylate, ethoxylated (3) bisphenol A dimethacrylate, ethoxylated (4) bisphenol A diacrylate, ethoxylated (4) bisphenol A dimethacrylate, and the like, as well as their mixtures.

In general, crosslinking polyacrylate(s) (b) can be present, in a first embodiment, at a level of from about 10 to about 50 weight percent, and in a second embodiment, at a level of from about 15 to about 35 weight percent, by weight of the entire monomer mixture.

Hydrophobic monoacrylate(s) (c) in the radiation-curable acrylate composition also contribute to the low water vapor and moisture absorption properties of the cured resin. In an optical disc, it is of particular importance to minimize permeation of water vapor and moisture as they may degrade the integrity of the reflecting layer and consequently the readability of the recorded data. The useful hydrophobic monoacrylates include those derived from aliphatic alcohols, e.g., of the cycloaliphatic (monocyclic, bicylic, etc.) and long chain aliphatic (e.g., chain length of from about 8 to about 22 carbon atoms) varieties. Useful hydrophobic cycloaliphatic monoacrylates (c) include isobornyl acrylate, cyclohexyl acrylate, 4-t-butylcyclohexylacrylate, dihydrodicyclopentadienyl acrylate, and the like, and their mixtures. Useful hydrophobic long chain aliphatic monoacrylates (c) include heptyl acrylate, isooctyl acrylate, isodecyl acrylate, tridecyl acrylate, lauryl acrylate, and the like, and their mixtures.

Any of the photoinitiators heretofore employed in the curing of acrylate-containing compositions can be used as photoinitiator(s) (d) herein. Examples of useful photoinitiators that can be used include 2-hydroxy-2-methyl-1-phenyl-propan-1-one, 2-methyl-1-[4-(methylthio)phenyl]-2-morpholino propan-1-one and blends of 1-hydroxycyclohexylphenyl acetone and diphenyl (2,4,6-trimethylbenzoyl) phosphine oxides. The photoinitiator(s) can be present in amounts of from about 0.25 to about 10 weight percent of the radiation-curable acrylate composition and are advantageously present therein at from about 2 to about 5 weight percent.

The viscosity of the totally formulated radiation-curable acrylate composition should be such as to facilitate its application without the need to add solvent or other non-reactive viscosity reducing component. In general, the radiation-curable acrylate composition herein can possess a viscosity of from about 500 to about 5000 cps at 25° C. and, advantageously, of from about 1000 to about 3000 cps at 25° C.

The radiation-curable acrylate composition can contain one or more optional components to impart yet additional desirable properties to the cured resin obtained therefrom. One especially useful class of additives is surfactants, in particular, silicone surfactants and perfluoro surfactants which, when added to the radiation-curable acrylate compositon, impart one or more additionally desirable properties to the cured resin such as resistance to fingerprints (i.e., antifingerprint capability) and other kinds of smudging, increased surface slip for improved abrasion resistance and improved coating uniformity, or leveling. In general, a surfactant can be present in the radiation-curable acrylate composition at a level of from about 0.05 to about 10 weight percent and, advantageously, at a level of from about 0.1 to about 2 weight percent. In one embodiment, a silicone surfactant such as a silicone polyether surfactant, and in another embodiment, a perfluoropolyether surfactant, can be utilized to impart an antifingerprint property to the cured resin. For example, Silwet L7657 (General Electric), a silicone polyether surfactant in which the polyether moiety is a poly(ethyleneoxide) chain, and Zonyl FSN (DuPont), a perfluoropolyether disclosed in U.S. Pat. No. 5,609,990, the contents of which are incorporated by reference herein, can be utilized within the aforestated amounts to confer antifingerprint capability upon the cured resin, an especially desirable property when the resin functions as the transparent protective layer of an optical data storage medium.

The cured resin obtained from the foregoing radiation-curable acrylate composition will possess a level of transparency enabling it to function as the protective coating of an optical data storage medium in accordance with the invention. Thus, for example, the cured acrylate coating will exhibit a transparency as measured by UV-Vis spectrameter in a first embodiment of at least about 90 percent and in a second embodiment of at least about 95 percent.

The cured resin constituting the transparent protective layer of the substrate herein exhibits a characteristically low modulus, understood as a tensile modulus of not greater than about 500 Mpa and, advantageously, of not greater than about 250 Mpa. In other embodiments, the cured resin will also exhibit a high elasticity, understood as an elongation at break of at least about 10 percent and, advantageously, of at least about 25 percent.

Other useful properties of the cured resin include a shrinkage of less than about 8 percent and, advantageously, of less than about 5 percent, a scratch resisitance are measured by the change in haze following Taber abrasion testing of less than about 5 percent and, advantageously, of less than about 2 percent, and a Tg of from about 20° to about 60° C. and, advantageously, from about 35 to about 50° C.

Still other desirable properties of the cured resin include a moisture absorbance (water pick-up) of not greater than about 1.5 weight percent, a contact angle with glycerol trioleate of at least about 30° and, advantageously, of at least about 45°, a surface resistivity of not greater than about 1×10⁻¹⁴ Ohms, a change in reflectivity following accelerated aging testing of less than about 20 percent and, advantageously, of less than about 10 percent, a relative birefringence, initially and following accelerated aging testing, of less than about 20 and, advantageously, of less than about 15.

The cured resin layer can be formed on the optical disc herein employing any of the known and conventional procedures. In one embodiment, the cured resin layer is obtained by applying a coating of radiation-curable coating composition to a disc to a predetermined thickness employing the known procedure of spincoating and at some time during or following the spincoating operation, exposing the composition to radiation, e.g., UV-light, under conditions that will achieve its cure. In one embodiment, the radiation-curable composition is applied to the disc surface employing a spin rate of from about 500 to about 3000 rpm for from about 1 to about 30 seconds and thereafter cured. A typical curing operation involves the use of a Fusion D or H bulb with a set intensity ranging between 1.384-2.8 W/cm² and a dosage of 0.304-2 J/cm² or Xenon Flash Bulb.

The thickness of the transparent protective layer can vary over fairly wide limits depending on the nature of the substrate to which it is applied and the functional requirements of the layer. In the case of optical data storage media, the thickness of this layer can, depending on the specific type of data storage medium, vary from about 50 to about 200 m and commonly from about 70 to about 120 m. In the particular case of BD, the thickness of the transparent protective layer will be on the order of about 100 m.

The entire desired thickness of curable resin can be provided in a single operation or in a series of spincoating/curing cycles wherein the desired thickness is built up in two or more stages. In the latter case, it may be advantageous to only partially cure a layer before applying the next layer and only completing the cure following the deposition of the last layer. The invention also contemplates the use of the radiation-curable acrylate composition to provide only the uppermost portion of the protective layer, e.g., the uppermost 2-10 m of the protective layer, the greater part of the protective layer being provided by any of the radiation-curable compositions heretofore known to provide the transparent protective coating of an optical disc.

Regardless of the technique employed for laying the acrylate-curable coating composition on the surface of the optical data storage medium, and particularly in the case of a high definition optical disc such as BD, it is desirable to maintain a highly uniform thickness of the coated composition, and hence the thickness of the resulting cured resin. In one embodiment, coating uniformity should be within about 5 percent and, advantageously, within about 3 percent, of the total average coating thickness.

An optical data storage disc possessing a transparent protective layer in accordance with the invention will advantageously further exhibit (1) an absolute value of the change in tilt following accelerated aging testing of not more than about 0.8° and, advantageously, of not more than about 0.5°, as measured at 55 mm radius, (2) an absolute value of change in tilt following humidity shock testing of not more than about 0.8° and, advantageously, of not more than about 0.5°, as measured at 55 mm radius, and (3) an absolute value of the change in tilt following heat shock testing of not more than about 0.8° and, advantageously, of not more than about 0.5°, as measured at 55 mm radius.

In the examples below, Examples 1-9 are illustrative of the invention while Comparative Examples 1 and 2 (illustrating the use of a hydrophilic monoacrylate monomer) are outside the scope of the inveniton. In all of the examples, a series of UV-curable acrylate compositions were prepared and spin coated on 60 mm radius disc substrates molded from polycarbonate OQ1030 (GE Plastics) or Noryl EXNL0090 (GE Plastics). Both of these substrates and substrates sputtered with silver alloy were used for coating. Coating thickness was adjusted to be about 100 m. Spincoating conditions varied based on the viscosity of the curable composition. Typical spincoat conditions were dispensing curable composition at the inner diameter (ID) of the disc, ramping to about 2000 rpm in 1 second and dwelling at this speed for 3 seconds. The curable compositions were typically cured for 2 sec using a Xenon RC-747 pulsed UV system equipped with a type D lamp.

Radial deviation and reflectivity of a cured resin coating were measured using a Dr. Schenk PROmeteus MT-200/Blu-ray instrument. Negative radial deviation occurs when the disc is concave on the coating side and positive deviation occurs when the disc is concave on the non-coated side of the disc.

For accelerated aging testing, discs were stacked on a spindle, coated side down, with a 1.7 mm ID, 3.0 mm OD and a Teflon washer was placed between each disc. The discs were placed in a humidity chamber employing the following temperature and humidity program: (1) ramp two hours from 25° C. to 80° C. and from 50% relative humidity (RH) to 8% RH; (2) 80° C., Ramp 2 hours to 85% RH, 3) 96 hours at 80° C., 85% RH; (4) 80° C., ramp 2 hours to 50% RH; (5) 6 hours at 80° C., 50% RH 6) ramp 2 hours to 25° C., 50% RH; (7) 36 hours at 25° C., 50% RH. Changes in tilt and reflectivity were recorded employing the Dr. Schenk instrument.

To test if discs would undergo corrosion of their metal layer due to the presence of fingerprints on the protective layer, five fingerprints were made on a disc by firmly pressing with a thumb on the protective layer for about a second such that a clearly discernable print was left on the disc surface. The discs were then subjected to the aging test at 80° C., 85% RH described above. After removal from the humidity chamber, discs were analyzed to determine whether corrosion could be observed on the metal layer beneath the areas with the fingerprints. The number of fingerprints that exhibited observable corrosion of the underlying metal layer was recorded.

A fingernail scratch recovery test was carried out as follows. A thumbnail was used to make a deep impression in the protective coating. The area was then wiped clean and the impression observed to determine the number of minutes required for the scratch to no longer be visible. An acceptable scratch recovery time is less than 2 minutes and a preferred recovery time is less than 1 minute.

### EXAMPLE 1

A UV-curable acrylate composition was prepared by combining and uniformly mixing Genomer 4316 (52.0 parts, available from Rahn USA), ethoxylated (4) bisphenol A diacrylate (30.0 parts), Irgacure 184 (2.0 parts, available from Ciba), Genocure TPO (0.2 parts, available from Rahn USA), Silwet L7657 (0.25 parts, available from GE) and isodecyl acrylate (15.5 parts). The composition was coated on a silver-coated Noryl disc and aged at 80° C. at 85% RH as described above.

### EXAMPLE 2

A UV-curable acrylate composition was prepared and coated as in Example 1 except that isobornyl acrylate was used in place of isodecyl acrylate.

### EXAMPLE 3

A UV-curable acrylate composition was prepared and coated as in Example 1 except that 1.5 weight % Irgacure 184 was used instead of 2 weight % Irgacure 184, and a predominantly hydrophobic blend of 50 weight % isodecyl acrylate and 50 weight % phenoxyethyl acrylate, a hydrophobic monoacrylate, was used in place of isodecyl acrylate.

### EXAMPLE 4

A UV-curable acrylate composition was prepared and coated as in Example 1 except that 1.5 weight % Irgacure 184 was used instead of 2 weight % Irgacure 184 and a predominantly hydrophobic blend of 75 weight % isodecyl acrylate and 25 weight % 2-phenoxyethyl acrylate was used in place of isodecyl acrylate.

### EXAMPLE 5

A UV-curable acrylate composition was prepared and coated as in Example 1 except that a blend of 50 weight % isobornyl acrylate and 50 weight % isodecyl acrylate was used in place of isodecyl acrylate.

### EXAMPLE 6

A UV-curable acrylate composition was prepared and coated as in Example 1 except that a blend of 25 weight % isobornyl acrylate and 75 weight % isodecyl acrylate was used in place of isodecyl acrylate.

### COMPARATIVE EXAMPLE 1

A UV-curable acrylate composition was prepared and coated as in Example 1 except that an equal weight amount of tetrahydrofurfuryl acrylate, a hydrophobic monoacrylate, was used in place of isodecyl acrylate.

### COMPARATIVE EXAMPLE 2

A UV-curable acrylate composition was prepared and coated as in Example 3 except that 100 weight % 2-phenoxyethyl acrylate was used in place of the blend of 50 weight % isodecyl acrylate and 50 weight % 2-phenoxyethyl acrylate.

The results of the aforedescribed tests carried out upon the coated discs of Examples 1-8 are set forth below in Table 1

TABLE 1

| | | | Number of | | | | | Fingernail |
|---|---|---|---|---|---|---|---|---|
| | | | Fingerprints | Radial | | | | Scratch |
| | | Water | Resulting in | Deviation | | % Reflectivity | | Recovery |
| Example | Monoacrylate | Pick-up | Corrosion | Initial | After aging | Initial | After aging | Time |
| 1 | IDA | | 0 | 0.04 | −0.58 | 32.2 | 28.0 | <1 min |
| 2 | IBOA | | 0 | −0.02 | −0.62 | 29.9 | 25.5 | >2 min |
| 3 | 50% IDA, 50% PhEA | | 0 | 0.04 | −0.43 | 32.3 | 28.4 | <1 min |
| 4 | 75% IDA, 25% PhEA | | 1 | 0.03 | −0.44 | 32.3 | 28.7 | <1 min |
| 5 | 50% IBOA, 50% IDA | | 0 | −0.01 | −0.58 | 32.0 | 28.1 | >2 min |
| 6 | 75% IDA, 25% IBOA | 1.31 | 1 | 0.01 | −0.61 | 31.8 | 27.9 | <2 min. |
| 7 | THFA | 1.68 | 5 | −0.05 | −0.77 | 31.2 | 26.4 | <1 min |
| 8 | PhEA | | 5 | 0.01 | −0.47 | 32.0 | 28.0 | <1 min |

IDA: isodecyl acrylate;
IBOA; isobornyl acrylate;
PHEA: 2-phenoxyethyl acrylate;
THFA: tetrahydrofurfuryl acrylate.

As the test data in Table 1 show, the cured resins of Examples 1-6 which were prepared with individual monoacrylates or with monoacrylate blends that were entirely or at least predominantly hydrophobic in character passed the fingerprint corrosion test while those that were prepared with a hydrophobic monoacrylate failed the test.

In Examples 7-9 below, the preparation and testing of the coated discs followed the general procedures described above except as specifically noted.

Surface resistivity was measured on a cured composition of about 100 m thickness on a polycarbonate disc employing resistance/resistivity probe Model 803B and Keithley 8487 Picoammeter from Electro-tech Systems.

Elongation at break was measured on a dumbbell-shaped sample cut from a 100 m thickness cured coating using Instron 4665. The elongation when the sample broke was measured as the elongation at break.

Percent light transmittance was measured on a cured composition of about 100 m thickness coated on a clear polycarbonate disc. An uncoated clear polycarbonate disc was used as a reference at measurement. A Cary 500 Scan UV-VIS-NIR spectrophotometer was used for the measurement.

Heat shock was performed by measuring the tilt change of a coated disc at 70° C. The tilt was measured as a mean radial deviation at 55 mm radius using the Dr. Schenk MT-200 PROmeteus instrument. After the initial tilt was measured, a coated BD was placed in a 70° C. oven sitting vertically in a metal rack. The disc was removed from the oven to measure the tilt at ambient conditions at a pre-determined interval of time. The disc was quickly placed back in the oven after making the measurement in order to minimize heat loss. A number of measurements were made to establish tilt change as a function of time. The maximum change of tilt from that before heating at 70° C. was recorded as the heat shock.

Humidity shock measures the tilt change of a coated disc experiencing humidity changes. A coated BD was placed in a humidity chamber set at 25° C. and 90% RH for at least 4 days to ensure that the disc was fully saturated with water vapor. The tilt of the disc, measured as a mean radial deviation at 55 mm radius with Dr. Schenk MT-200 PROmeteus, was measured immediately after the disc was removed from the chamber. The tilt was monitored every hour for 8 hours. The maximum change of the tilt from the initial tilt was recorded as the humidity shock.

Taber abrasion resistance was measured according to ASTM D1044-99. CS-10F wheel at load of 250 g running for 5 cycles was used for this measurement.

### EXAMPLE 7

A UV-curable acrylate composition prepared as in Example 6 was spin coated on a disc as described above except that instead of curing the disc only after the spinning had stopped, the spinning was slowed to about 400 rpm whereupon the coating was partially cured using a 250W arc lamp while spinning continued. Spinning was then stopped and the curing of the coating completed employing 20 pulses of light from a Xenon Model RC801 exposure unit equipped with a D bulb.

### EXAMPLE 8

A UV-curable acrylate composition was prepared containing 100 g of the formulation of Example 6 and 0.4 g of FSO100 fluorocarbon surfactant (DuPont). The composition was coated on a disc as in Example 1 except that instead of curing for 2 sec (20 pulses) with a Xenon RC-747 pulsed UV system, the sample was cured for 30 pulses utilizing a Xenon RC801 exposure unit equipped with a D bulb.

### EXAMPLE 9

The UV-curable coating composition of Example 7 was coated on a disc as described therein except that the coating was partly cured while spinning at about 400 rpm using a 250W arc lamp with curing completed with 30 pulses employing a Xenon RC801 exposure unit equipped with a D bulb.

The results of testing the coated discs of Examples 7-9 are set forth below in Table 2.

TABLE 2

| Property | Example 7 | Example 8 | Example 9 |
|---|---|---|---|
| Coating Tg | 37° C. | | |
| Coating Modulus | 169 Mpa | | |
| Coating Elongation at Break | 40% | | |
| Coating Shrinkage after Cure | 4.1% | | |
| Coating Taber Abrasion Delta Haze | 2.7% | 1.7% | |
| Coating Contact Angle, glycerol trioleate | 51.5° | | |
| Coating Transmission at 405 nm | 95% | | |
| Coating Moisture Pick-up | 1.3% | | |
| Disc Surface Resistivity | 2.9 × 10¹² | | |
| | Ohm/square | | |
| Disc Delta Radial Deviation after curing | 0.01 | 0.06 | 0.15 |
| Disc Delta Radial Deviation after aging for 4 days, | −0.29 | −0.76 | −0.40 |
| 80° C. at 85% RH | | | |
| Disc Delta Radial Deviation after aging for 5 days at | 0.18 | 0.37 | −0.45 |
| 25° C., 90% RH | | | |
| Disc Delta Radial Deviation after heat shock | 0.27 | 0.05 | 0.04 |
| Coating Fingernail Scratch Recovery Time | <1 min | | |
| Number of Fingerprints Resulting in Corrosion | 0 | | |
| Disc Coating Thickness Range | 97–103 microns | | 97–103 |

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention, but that the invention will include all embodiments falling within the scope of the appended claims.

What is claimed is:

1. A substrate possessing a transparent protective layer derived from a radiation-curable acrylate composition which comprises:
a) at least one urethane polyacrylate possessing a number average molecular weight of at least about 400 per acrylate group and having a T_{g} of not greater than about 40° C.;
b) at least one crosslinking polyacrylate having a T_{g} of at least about 50° C.;
c) at least one hydrophobic monoacrylate; and,
d) at least one photoinitiator.

2. The substrate of claim 1 wherein urethane polyacrylate (a) is a diacrylate or triacrylate possessing a number average molecular weight of at least about 600 per acrylate group.

3. The substrate of claim 2 wherein the urethane diacrylate or triacrylate is aliphatic polyester-based.

4. The substrate of claim 1 wherein the radiation-curable acrylate composition contains from about 20 to about 70 weight percent urethane polyacrylate (a) by weight of all the acrylate monomers.

5. The substrate of claim 1 wherein the radiation-curable acrylate composition comprises from about 40 to about 60 weight percent urethane polyacrylate (a) by weight of all the acrylate monomers.

6. The substrate of claim 1 wherein crosslinking polyacrylate (b) is an alkoxylated bisphenol A diacrylate possessing a molecular weight of less than about 400 per acrylate group.

7. The substrate of claim 6 wherein the bisphenol A diacrylate contains from about 1 to about 6 ethoxylate units.

8. The substrate of claim 1 wherein the radiation-curable acrylate composition contains from about 10 to about 50 weight percent crosslinking polyacrylate (b) by weight of all the acrylate monomers.

9. The substrate of claim 1 wherein the radiation-curable acrylate conposiiton contains from about 15 to about 35 weight percent crosslinking polyacrylate (b) by weight of all the acrylate monomers.

10. The substrate of claim 1 wherein hydrophobic monoacrylate (c) is at least one member selected from group consisting of cycloaliphatic monoacrylates and long chain aliphatic monoacrylates.

11. The substrate of claim 10 wherein the cycloaliphatic monoacrylate is at least one member selected from the group consisting of isobornyl acrylate, cyclohexyl acrylate, 4-t-butylcyclohexylacrylate and dihydrodicyclopentadienyl acrylate.

12. The substrate of claim 10 wherein the long chain aliphatic monoacrylate is at least one number selected form the group consisting of heptylacrylate, isooctylacrylate, isodecyl acrylate, tridecylacrylate and lauryl acrylate.

13. The substrate of claim 1 wherein the radiation-curable acrylate composition contains form about 5 to about 30 weight percent hydrophobic monofunctional acrylate (c) by weight of all the acrylate monomers.

14. The substrate of claim 1 wherein the radiation-curable acrylate composition contains form about 10 to about 20 weight percent hydrophobic monoacrylate (c) by weight of all the acrylate monomers.

15. The substrate claim 1 wherein photoinitiator (d) is a mixture of alpha hydroxy ketone and arylphosphine oxide.

16. The substrate of claim 1 wherein the radiation-curable acrylate composition contains from about 0.5 to about 5 weight percent photoinitator(s) (d).

17. The substrate of claim 1 wherein the radiation-curable acrylate composition contains a surfactant.

18. The substrate of claim 17 wherein the surfactant is at least one member selected from the group consisting of silicone surfactant and perfluoro surfactant.

19. The substrate of claim 18 wherein the silicone surfactant is a silicone polyether.

20. The substrate of claim 18 wherein the perfluoro surfactant is a perfluoropolyether.

21. The substrate of claim 1 wherein the radiation-curable acrylate composition comprises:
a) at least one aliphatic polyester-based polyurethane diacrylate or triacrylate in an amount of from about 30 to about 70 by weight of all the acrylate monomers;
b) at least one alkoxylated bisphenol A diacrylate in an amount of from about 15 to about 35 by weight of all the acrylates;
c) at least one hydrophobic monoacrylate selected from the group consisting of cycloaliphatic monoacrylate and long chain aliphatic monoacrylate in an amount of from about 10 to about 30 percent by weight of all the acrylate monomers;
d) at least one phohotinitiator; and,
e) optionally, at least one surfactant.

22. The substrate of claim 1 wherein the transparent protective layer possesses a modulus of not greater than about 500 MPa.

23. The substrate of claim 1 wherein the transparent protective layer possesses a modulus of not greater than about 250 MPa.

24. The substrate of claim 1 wherein the transparent protective layer possesses an elongation at break of at least about 8 percent.

25. The substrate of claim 1 wherein the transparent protective layer possesses an elongated break of at least about 25 percent.

26. The substrate of claim 1 wherein the transparent protective layer exhibits a contact angle of glycerol trioleate of at least about 30° and a finger scratch recovery time of less than about 2 minutes.

27. The substrate of claim 1 wherein the transparent protective layer exhibits a contact angle of glycerol trioleate of at least about 40° and a finger scratch recovery time of less than about 1 minute.

28. The substrate of claim 21 wherein the transparent protective layer possesses a modulus of not greater than about 500 MPa, an elongation at break of at least about 8 percent, a contact angle of glycerol trioleate of at least about 30° and a finger scratch recovery time of less than about 2 minutes.

29. The substrate of claim 21 wherein the transparent protective layer possesses a modulus of not greater than about 250 MPa, an elongation at break of at least about 25 percent, a contact angle of glycerol trioleate of at least about 40° and a finger scratch recovery time of less than about 1 minute.

30. The substrate of claim 1 wherein the transparent protective layer exhibits a shrinkage of less than about 8 percent.

31. The substrate of claim 21 wherein the transparent protective layer exhibits a shrinkage of less than about 8 percent.

32. The substrate of claim 1 which is a CD, DVD, HD DVD or BD.

33. The substrate of claim 17 which is a CD, DVD, HD DVD or BD.

34. The substrate of claim 21 which is a CD, DVD, HD DVD or BD.
